(19) United States
(12) Patent Application Publication
(10) Pub. No.: US 2024/0375037 A1
(43) Pub. Date: Nov. 14, 2024

(54) Apparatus and Process for Oxygen Production

(71) Applicant: Air Products and Chemicals, Inc., Allentown, PA (US)

(72) Inventors: JAY A. THAKKAR, ALLENTOWN, PA (US); ALAN D. BERGER, AMBLER, PA (US); SIMON GIBSON, SURREY (GB)

(73) Assignee: Air Products and Chemicals, Inc., Allentown, PA (US)

(21) Appl. No.: 18/144,908

(22) Filed: May 9, 2023

(51) Int. Cl. B01D 53/04; B01D 53/26; C01B 13/02; C25B 15/08

(52) U.S. Cl. CPC B01D 53/0446; B01D 53/0438; B01D 53/261; C01B 13/0277; C25B 15/081; C25B 15/085; B01D 2256/12; B01D 2257/80; B01D 2259/4009; C01B 2210/0021

(57) ABSTRACT

An apparatus and process for oxygen production can be configured to utilize flash vapor losses, recovery of regeneration heat and/or utilize a compressor to provide better heat integration and/or less wasteful processing for the recovery of oxygen that can be obtained from electrolysis (e.g., operation of one or more electrolyzers). Some embodiments may utilize all three of these features while other embodiments may use only one of these features or a combination of two of these features.

### TECHNICAL FIELD

The present innovation relates to processes and systems for the recovery of oxygen during the production of hydrogen gas obtained via one or more electrolyzers.

### BACKGROUND

Electrolyzers can produce hydrogen from water via electrolysis. Examples of electrolyzers that produce hydrogen gas can be appreciated from U.S. Pat. Nos. 5,512,145 and 9,328,426 as well as U.S. Patent Application Publication No. 2022/0283567, European Patent Publication No. EP4001462, German Patent Publication No. DE102019008985A1, International Publication Nos. WO 2017/084589 and 2021/160235, Chinese Patent Publication Nos. CN114214637A, CN113562701A, CN101407921A, and Chinese Utility Model Patent Nos. CN203923390U and CN210512327U.

### BRIEF SUMMARY OF THE INVENTION

We determined that oxygen can be recovered from electrolysis output flows to provide a double benefit of reducing overall process waste while also providing at least one product stream of oxygen in addition to hydrogen that can be output from the electrolysis processing. For example, at least one electrolyzer can produce a stream of hydrogen gas as well as a second stream that can include oxygen and water. Such a second stream may also include some hydrogen. For example, the second stream from the electrolysis processing can be separated from a hydrogen gas stream and subsequently utilized in downstream processing instead of just venting that gas of the second stream or otherwise disposing of that gas as a waste stream. In some configurations, embodiments we have developed can permit oxygen to be recovered from an electrolysis process that can provide improved energy usage (e.g. improvements in utilization of heat or heat transfer) and/or process flexibility as well as providing an output of oxygen product in addition to hydrogen product from an electrolysis based process using one or more electrolyzers.

In some embodiments, flash vapor losses from liquefaction (e.g. at least one liquefier) and/or recovering regeneration heat can be utilized to provide improved efficient operation and reduce waste. Embodiments can be provided so that processing upstream of a liquefier can provide an improved heat integration that results in a less wasteful process for the recovery of oxygen generated from electrolysis, which may be output from one or more electrolyzers.

In a first aspect, an apparatus for oxygen production can include a reactor positioned to receive a feed comprising oxygen and water for dehydrogenation of the feed and output dehydrogenated feed and a cooler positioned to receive the dehydrogenated feed output from the reactor to cool the dehydrogenated feed to a temperature within a pre-selected temperature range. An adsorption system can be positioned to receive at least a portion of the cooled dehydrogenated feed after it is output from the cooler to remove moisture and/or impurities from the dehydrogenated feed to output an oxygen gas stream that is comprised of at least 90 volume percent (vol %) oxygen.

In a second aspect, embodiments of the apparatus can also include a compressor system positioned upstream of the reactor to compress the feed to a pre-selected reactor feed pressure before the feed is fed to the reactor and/or a reactor feed heating system positioned to heat the feed to a temperature within a pre-selected reactor feed temperature range before the feed is fed to the reactor and receive the dehydrogenated stream output from the reactor as a heating medium for heating the feed. Some implementations may only use the compressor system while other may only use the reactor feed heating system. Yet other implementations may utilize both the compressor system and the reactor feed heating system.

In a third aspect, the apparatus can include a liquefaction unit having at least one liquefier positioned to receive at least a portion of the oxygen gas stream output from the adsorption system to liquify the oxygen gas stream and a separator positioned to receive liquified oxygen from the liquefaction unit to output a liquid oxygen stream and an oxygen gas stream. A feed pre-cooler can also be positioned upstream of the compressor system and/or the reactor feed heating system. The feed pre-cooler can be positioned to cool the feed before the feed is fed to the compressor system and/or the reactor feed heating system. The feed pre-cooler can also be positioned to receive at least a portion of the oxygen gas stream output from the separator as a cooling medium to cool the feed.

In a fourth aspect, the apparatus can include a liquefaction unit having at least one liquefier positioned to receive at least a portion of the oxygen gas stream output from the adsorption system to liquify the oxygen gas stream and a separator positioned to receive liquified oxygen from the liquefaction unit to output a liquid oxygen stream and an oxygen gas stream. The oxygen gas stream can be outputtable to feed at least a portion of the oxygen gas stream to the cooler as a cooling medium for cooling of the dehydrogenated feed. The cooler can be positioned to output the cooling medium as a warmed cooling medium to feed toward the adsorption system as a regeneration gas for regeneration of adsorbent material of at least one adsorber of the adsorption system.

In a fifth aspect, the apparatus can include a liquefaction unit having at least one liquefier positioned to receive at least a portion of the oxygen gas stream output from the adsorption system to liquify the oxygen gas stream and a separator positioned to receive liquified oxygen from the liquefaction unit to output a liquid oxygen stream and an oxygen gas stream. The oxygen gas stream can be outputtable to feed at least a portion of the oxygen gas stream toward the adsorption system as a regeneration gas for regeneration of adsorbent material of at least one adsorber of the adsorption system.

In some embodiments, a regeneration gas heat exchanger can be positioned adjacent the adsorption system to receive the regeneration gas from the separator to heat the regeneration gas to a temperature within a pre-selected regeneration gas temperature range before the regeneration gas is fed to the at least one adsorber of the adsorption system to regenerate the adsorbent material of the at least one adsorber of the adsorption system.

In a sixth aspect, the reactor can be connectable to the adsorption system so that a portion of the dehydrogenated feed output from the reactor is feedable to the adsorption system as a regeneration gas. A treatment device can be positioned between the reactor and the adsorption system to treat the portion of dehydrogenated feed output from the reactor to form the regeneration gas for feeding to the adsorption system. The treatment device can be a phase separator that outputs a liquid stream comprising impurities separated from the dehydrogenated feed to form the regeneration gas in some embodiments.

In a seventh aspect, the apparatus can include a regeneration gas heat exchanger positioned to heat a regeneration gas to a temperature within a pre-selected regeneration gas temperature range for feeding the regeneration gas to the adsorption system. The reactor can be connectable to the regeneration gas heat exchanger so that a portion of the dehydrogenated feed output from the reactor is feedable to the regeneration gas heat exchanger as a heating medium for heating the regeneration gas. The regeneration gas heat exchanger can be connectable to the cooler to feed the heating medium to the cooler or to merge the heating medium with the dehydrogenated feed stream output from the reactor for feeding to the cooler.

In an eighth aspect, the apparatus can include a regeneration gas heat exchanger positioned to heat a regeneration gas to a temperature within a pre-selected regeneration gas temperature range for feeding the regeneration gas to the adsorption system and a moisture removal unit positioned between the adsorption system and the regeneration gas heat exchanger. The moisture removal unit can be configured to receive regeneration gas output from the adsorption system to remove moisture from the regeneration gas and subsequently feed the regeneration gas to the regeneration gas heat exchanger to be heated to the temperature within the pre-selected regeneration gas temperature range for being fed back to the adsorption system in a closed-loop arrangement. In some embodiments, the moisture removal unit can include or can be a dehydrator, a condenser, or an adsorber.

In a ninth aspect, the apparatus can include a phase separator positioned between the cooler and the adsorption system to remove water from the cooled dehydrogenated feed as a liquid waste stream before the cooled dehydrogenated feed is fed to the adsorption system.

In a tenth aspect, the apparatus can include a phase separator positioned between the cooler and the adsorption system to remove water from the cooled dehydrogenated feed as a liquid waste stream before a first portion of the cooled dehydrogenated feed is fed to the adsorption system. A regeneration gas heat exchanger can be positioned between the phase separator and the adsorption system. The phase separator can be connectable to the adsorption system and the regeneration gas heat exchanger such that a second portion of the cooled dehydrogenated feed is feedable to the regeneration gas heat exchanger to be heated to a pre-selected regeneration gas temperature for being fed to the adsorption system as a regeneration gas.

In an eleventh aspect, the apparatus of the first aspect can include one or more features from the second aspect, third aspect, fourth aspect, fifth aspect, sixth aspect, seventh aspect, eighth aspect, ninth aspect, and/or tenth aspect. It should therefore be appreciated that various other elements can be included in the apparatus to provide other embodiments of our apparatus.

In a twelfth aspect, a process for production of oxygen from a feed output from at least one electrolyzer can include feeding a feed output from at least one electrolyzer to a reactor to form a dehydrogenated feed, the feed comprising oxygen and water and outputting the dehydrogenated feed from the reactor. The process can also include passing at least a portion of the dehydrogenated feed output from the reactor to a cooler to cool the dehydrogenated feed to a temperature within a pre-selected temperature range and for forming a cooled dehydrogenated feed and feeding the cooled dehydrogenated feed towards an adsorption system to remove moisture and/or impurities from the cooled dehydrogenated feed to output an oxygen gas stream that is comprised of at least 90 volume percent (vol %) oxygen.

Embodiments of our apparatus can be configured to utilize an embodiment of our process. It should also be appreciated that embodiments of our process can include other steps or features.

For instance, in a thirteenth aspect, the process can include compressing the feed to a pre-selected reactor feed pressure before the feed is fed to the reactor and/or heating the feed to a temperature within a pre-selected reactor feed temperature before the feed is fed to the reactor wherein the heating of the feed to the temperature within the pre-selected reactor feed temperature utilizes at least a portion of the dehydrogenated feed output from the reactor.

Embodiments of the process can also include liquifying at least a portion of the oxygen gas stream to form a liquified oxygen fluid after the oxygen gas stream is output from the adsorption system. The liquified oxygen fluid can be fed to a separator to form a liquid oxygen product and an oxygen gas stream. The oxygen gas stream can be utilizable as a process gas stream.

Embodiments of the process can also include at least one of: (i) feeding at least a portion of the process gas stream to a pre-feed cooler as a cooling medium for pre-cooling the feed before the feed is fed to the reactor and subsequently passing the cooling medium fed to the pre-feed cooler toward the adsorption system as a regeneration gas after the cooling medium is warmed via the pre-cooling of the feed; (ii) feeding at least a portion of the process gas stream to the cooler as a cooling medium for cooling the dehydrogenated feed and subsequently passing the cooling medium fed to the cooler toward the adsorption system as a regeneration gas after the cooling medium is warmed via the cooling of the dehydrogenated feed; (iii) feeding at least a portion of the process gas stream toward the adsorption system as a regeneration gas for passing through at least one off-line adsorber to regenerate adsorbent material of the at least one off-line adsorber; and (iv) feeding at least a portion of the process gas stream to a regeneration gas heat exchanger to be heated to a temperature within a pre-selected regeneration gas temperature range for passing the portion of the process gas to the adsorption system as a regeneration gas for passing through at least one off-line adsorber to regenerate adsorbent material of the at least one off-line adsorber.

In a fourteenth aspect, the process can include splitting the dehydrogenated feed output from the reactor so a first portion of the dehydrogenated feed is fed to the cooler and a second portion of the dehydrogenated feed is fed to the adsorption system as a regeneration gas.

In a fifteenth aspect, the process can include splitting the dehydrogenated feed output from the reactor so a first portion of the dehydrogenated feed is fed to the cooler and a second portion of the dehydrogenated feed is fed to a regeneration gas heat exchanger as a heating medium for heating a regeneration gas to be fed to the adsorption system and subsequently feeding the heating medium from the regeneration gas heat exchanger to the cooler after the heating medium is utilized for heating of the regeneration gas.

In a sixteenth aspect, the process can include splitting the dehydrogenated feed output from the reactor so a first portion of the dehydrogenated feed is fed to the cooler and a second portion of the dehydrogenated feed is fed to a treatment device for forming a regeneration gas for feeding to the adsorption system and outputting the regeneration gas from the treatment device to feed the regeneration gas to the adsorption system.

In a seventeenth aspect, the process can include the adsorption system outputting a regeneration gas from at least one off-line adsorber of the adsorption system and a moisture removal unit receiving the regeneration gas output from the adsorption system to remove moisture and/or impurities from the regeneration gas to purify the regeneration gas. The purified regeneration gas output from the moisture removal unit can be fed to the adsorption system.

In an eighteenth aspect, the process of the twelfth aspect can include one or more features from the thirteenth aspect, fourteenth aspect, fifteenth aspect, sixteenth aspect, and/or seventeenth aspect. It should therefore be appreciated that various other elements can be included in the process to provide other embodiments of our process.

It should be appreciated that embodiments of the process and apparatus can utilize various conduit arrangements and process control elements. The embodiments may utilize sensors (e.g., pressure sensors, temperature sensors, flow rate sensors, concentration sensors, etc.), controllers, valves, piping, and other process control elements. Some embodiments can utilize an automated process control system and/or a distributed control system (DCS), for example. Various different conduit arrangements and process control systems can be utilized to meet a particular set of design criteria.

Other details, objects, and advantages of our process for oxygen production, an apparatus for oxygen production, a system for oxygen production, and methods of making and using the same will become apparent as the following description of certain exemplary embodiments thereof proceeds.

### BRIEF DESCRIPTION OF THE DRAWINGS

Exemplary embodiments of processes for oxygen production, apparatuses for oxygen production, and systems for oxygen production, and methods of making and using the same are shown in the drawings included herewith. It should be understood that like reference characters used in the drawings may identify like components.

FIG. 1 is a block diagram of a first exemplary embodiment of an apparatus 1 for oxygen production. Exemplary embodiments of a process for oxygen production that can be implemented utilizing the first exemplary embodiment of the apparatus 1 for oxygen production are also illustrated in FIG. 1. Various optional elements and streams of the apparatus 1 are shown in broken line in FIG. 1.

FIG. 2 is a block diagram of a first exemplary implementation of the first exemplary embodiment of the apparatus 1 for oxygen production.

FIG. 3 is a block diagram of a second exemplary implementation of the first exemplary embodiment of the apparatus 1 for oxygen production.

FIG. 4 is a block diagram of a third exemplary implementation of the first exemplary embodiment of the apparatus 1 for oxygen production.

FIG. 5 is a block diagram of a fourth exemplary implementation of the first exemplary embodiment of the apparatus 1 for oxygen production.

FIG. 6 is a block diagram of a fifth exemplary implementation of the first exemplary embodiment of the apparatus 1 for oxygen production.

FIG. 7 is a block diagram of a sixth exemplary implementation of the first exemplary embodiment of the apparatus 1 for oxygen production.

FIG. 8 is a block diagram of a seventh exemplary implementation of the first exemplary embodiment of the apparatus 1 for oxygen production.

FIG. 9 is a block diagram of an eighth exemplary implementation of the first exemplary embodiment of the apparatus 1 for oxygen production.

FIG. 10 is a block diagram of a ninth exemplary implementation of the first exemplary embodiment of the apparatus 1 for oxygen production.

FIG. 11 is a flow chart of an exemplary embodiment of the process for oxygen production that can be implemented by the first exemplary embodiment of the apparatus 1 or second exemplary embodiment of the apparatus.

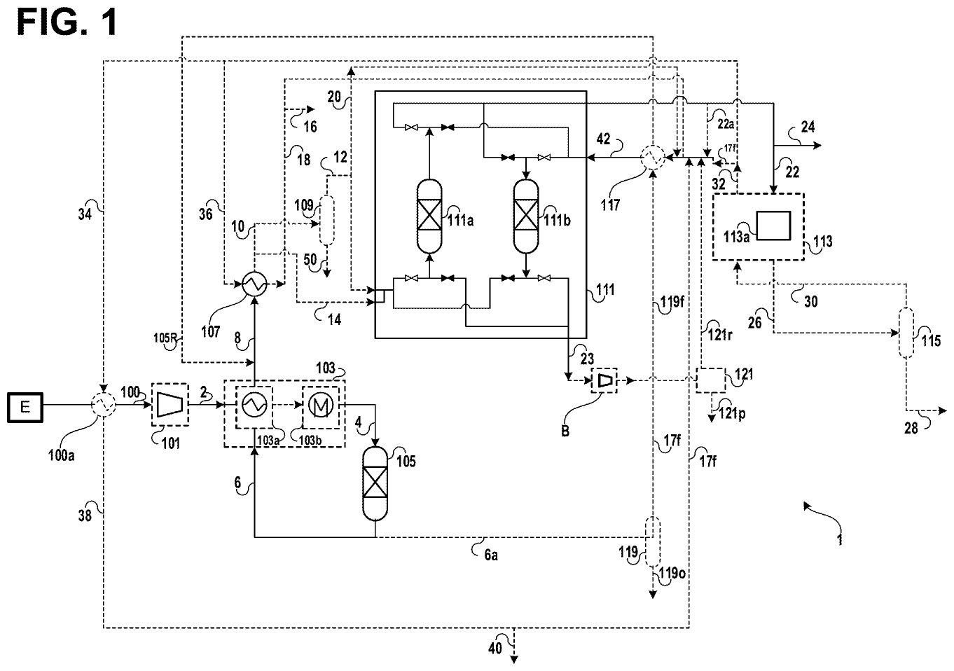

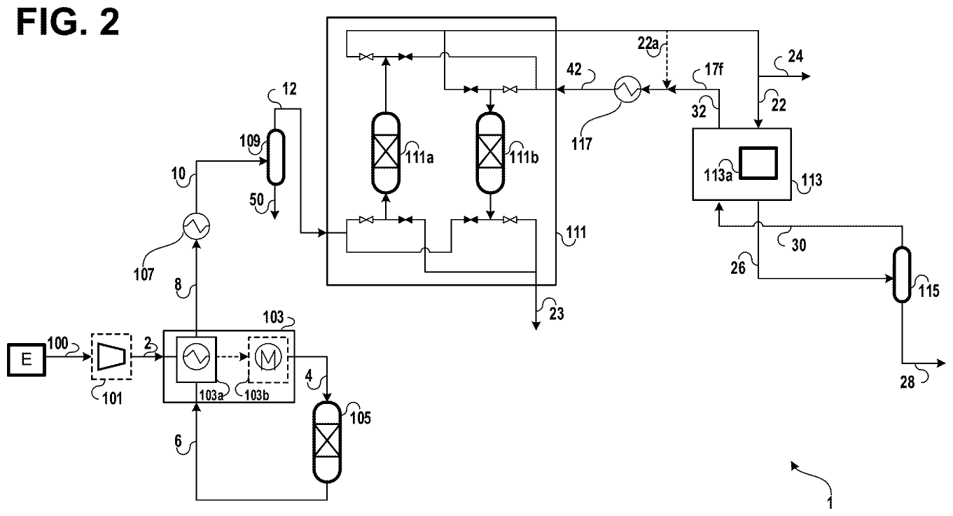

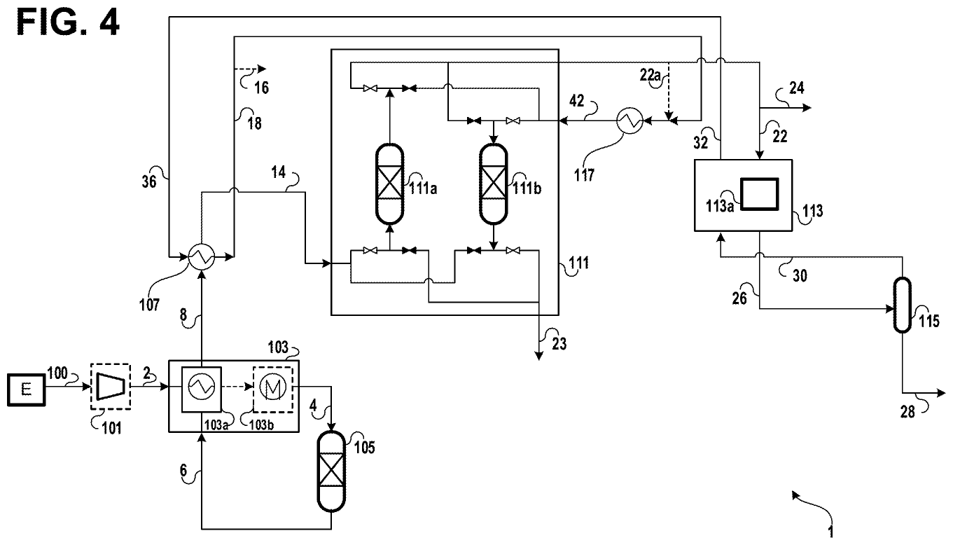

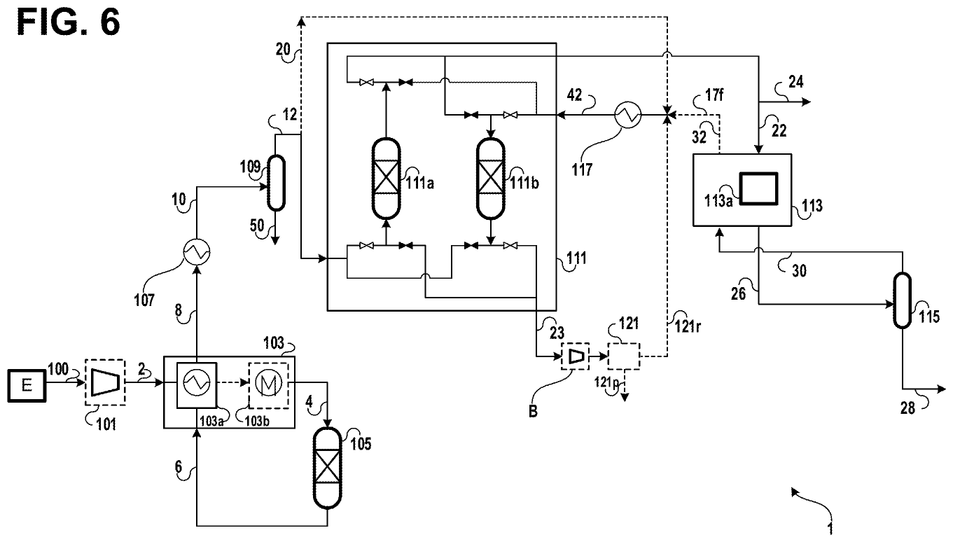

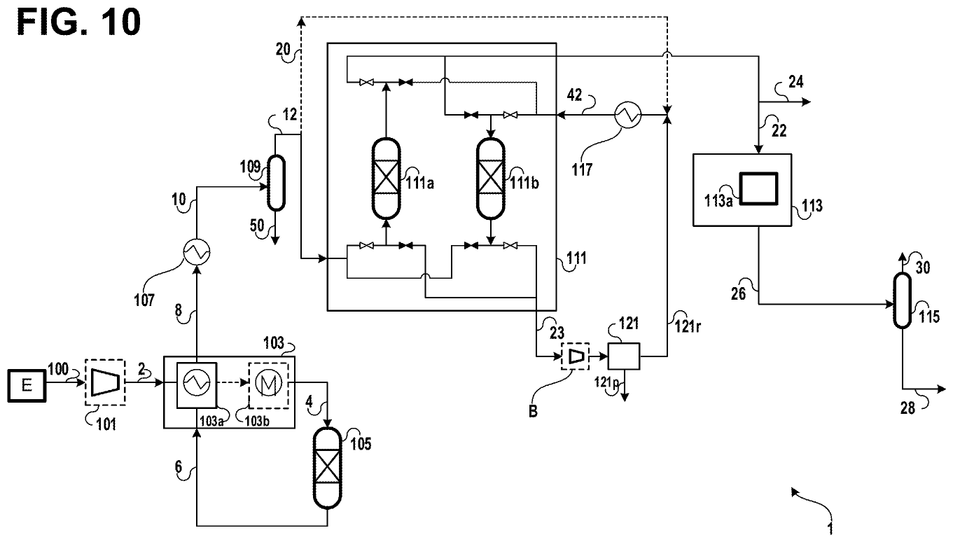

It should be appreciated that FIGS. 2-7 and 10 include illustration of various optional elements in broken line that may or may not be included in some implementations of that particularly illustrated exemplary implementation of the first exemplary embodiment of the apparatus 1. Also, arrows illustrated in FIGS. 1-10 to indicate various flows of fluid can include conduits between the different process elements. The conduits can include valves, piping and/or other conduit elements for connecting elements so that the flows are passable between the different process elements.

Also, it should be understood that FIGS. 2-10 illustrate exemplary embodiments of processes for oxygen production that can be implemented utilizing the first exemplary embodiment of the apparatus 1 for oxygen production.

### DETAILED DESCRIPTION

Referring to FIGS. 1-11, an apparatus 1 for the production of oxygen can be configured to process a feed 100 of gas output from at least one electrolyzer E. The gas of the feed 100 can include a gas comprising oxygen and water vapor that can be output from at least one electrolyzer E during operation of the electrolyzer(s) to form hydrogen gas from water via an electrolysis process, for example.

The hydrogen gas (H2) from the electrolyzer(s) E can also be output from the electrolyzer(s) E and be transported to storage or other plant unit (not shown). An additional process stream comprising water and oxygen can be output from the electrolyzer(s) E as a feed 100 for the apparatus 1 for oxygen production. The feed 100 can also include hydrogen (e.g. between 2 volume percent (vol %) hydrogen and 0 vol % hydrogen, less than 2 vol % hydrogen, etc.) at a concentration that is significantly lower than the concentration of oxygen within the feed 100 (e.g. oxygen can be at least 70 vol % of the feed, at least 80 vol % of the feed, etc.). Water content for the feed 100 can be in a range of 3 vol % and 10 vol % or other suitable range. The feed 100 can also include trace amounts of electrolyte material (e.g. KOH, etc.) and other impurities that may still be present in the feed 100 after it is output from at least one electrolyzer E.

The apparatus 1 for oxygen production can be configured to process the feed 100 to remove moisture (e.g. water) and/or other impurities from the feed 100 for the formation of at least one stream of oxygen (e.g. a liquid oxygen product stream and/or a gaseous oxygen product stream). The oxygen product that is formed can include at least one oxygen gas product stream and/or at least one liquid oxygen product stream, for example. Each oxygen product stream can be at least 90 vol % oxygen (e.g. between 90 vol % oxygen and 100 vol % oxygen), or other suitable oxygen concentration range (e.g. at least 80 vol % oxygen, at least 95 vol % oxygen, between 95 vol % oxygen and 99.99 vol % oxygen, etc.).

The apparatus 1 can include a compressor system 101 positioned to compress the feed 100 output from the at least one electrolyzer E. A feed pre-treatment device (Feed Pre-Treat) 100a can be positioned between the electrolyzer(s) E and the compressor system 101 to filter the feed to remove one or more impurities and/or cool the feed to a temperature within a pre-selected feed temperature range before the feed 100 is fed to the compressor system 101. The feed pre-treatment device 100a can include a filtration mechanism (e.g. coalescing filter, coalescers, etc.) for removing impurities from the feed (e.g. electrolyte material, which can include KOH or other electrolyte material, etc.). The feed pre-treatment device can also include a cooler or chiller.

The compressor system 101 can include at least one compressor for compression of the feed to a pre-selected oxygen processing pressure for the feed 100. The compressed feed can be output from the compressor system 101 as a compressed feed stream 2 for being fed to a reactor 105. The compressed feed can be at a pre-selected compressed feed pressure within a pre-selected compressed feed pressure range. For example, the pre-selected compressed feed pressure range can be greater than or equal to 20 bar gauge (barg), be greater than 0 barg and less than or equal to 20 barg, be greater than or equal to 40 bar, greater than 5 bar, between 5 bar and 60 bar, or other suitable pressure.

In some implementations, the compressed feed stream can be fed to the reactor 105 directly after being output from the compressor system 101. In other implementations, a reactor feed heating system 103 (Reactor Feed Heating System) can be positioned between the reactor 105 and the compressor system 101 to heat the compressed feed stream 2 before that stream is fed to the reactor 5.

The reactor feed heating system 103 (when utilized) can be configured to pre-heat the compressed feed stream 2 to a temperature within a pre-selected reactor feed temperature range. For example, the reactor feed heating system 103 can include a first heat exchanger 103a and/or a second heat exchanger 103b for heating of the compressed feed stream 2 to the temperature within the pre-selected reactor feed temperature range. The second heat exchanger 103b can be configured as a startup heat exchanger for operation during startup operations and subsequently not be utilized after the reactor 105 has been in operation for a period of time and the process is running continuously for at least a start-up time period. In other embodiments, no second heat exchanger 103b may be utilized at all or the second heat exchanger 103b can be utilized to provide additional heating to supplement the heating provided by the first heat exchanger 103a. In yet other embodiments, no first heat exchanger 103a may be used and only the second heat exchanger 103b can be utilized. In such an embodiment, the second heat exchanger 103b could be considered a first heat exchanger.

A heated compressed feed stream 4 can be output from the reactor feed heating system 103 for being fed to the reactor 105. The reactor 105 can be configured as a catalytic reactor, a catalytic conversion unit, or other type of reactor. The vessel of the reactor can include catalyst material therein (e.g., at least one bed of catalytic material, at least one membrane, etc.) to facilitate a reaction with the feed passed through the reactor for dehydrogenation of the feed, for example. The dehydrogenation of the feed provided by the reactor 105 can remove hydrogen from the feed to dehydrogenate the feed and form a dehydrogenated stream 6. The hydrogen can be removed via the reactor 105 such that the hydrogen content of the dehydrogenated stream 6 is less than 0.1 vol % or between 0.2 vol % to 0 vol % or other pre-selected hydrogen content within a pre-selected hydrogen content range.

The reactor 105 can output a dehydrogenated stream 6 for feeding to at least one cooler 107 (O2 Cooler) for cooling the dehydrogenated stream 6. The at least one cooler 107 can include a single cooler or can include an arrangement of multiple coolers that are positioned for cooling the dehydrogenated stream 6 in series (e.g. includes a first cooler that then feeds cooled dehydrogenated stream to a second downstream cooler for further cooling) or can include multiple coolers arranged in parallel to each cool a portion of the dehydrogenated stream for subsequent output at pre-selected temperatures. In some arrangements that utilize a reactor feed heating system 103, at least a portion of the dehydrogenated stream 6 output from the reactor 105 can be fed to the reactor feed heating system 103 to provide a heating medium for pre-heating the feed 100. For example, the dehydrogenated stream 6 can be fed to the first heat exchanger 103a to function as the heating medium for that heat exchanger for heating of the feed stream fed to the first heat exchanger 103a. The dehydrogenated stream 6 can be cooled by transferring some of its heat to the feed 100 via the reactor feed heating system 103. The cooled dehydrogenated stream 8 output from the reactor feed heating system 103 can then be fed to at least one cooler 107 to undergo further cooling. Of course, in embodiments that do not utilize the reactor feed heating system 103, the dehydrogenated stream 6 can be fed from the reactor 105 to a first cooler of the at least one cooler 107 without having to be passed through the reactor feed heating system 103.

The at least one cooler 107 can include a chiller (e.g., absorption chiller, mechanical chiller etc.) and/or other type of heat exchanger. In some arrangements, the at least one cooler 107 can include at least one heat exchanger that uses a stream of oxygen (e.g., gaseous oxygen) output from a liquefaction unit 113 or separator 115 downstream of at least one liquefier 113a of the liquefaction unit 113 as a cooling medium for cooling the dehydrogenated stream 6 output from the reactor 105 or the cooled dehydrogenated stream 8 output from the reactor feed heating system 103. Other implementations can utilize a different type of cooler arrangement (e.g., mechanical chiller, absorption chiller, etc.).

The at least one cooler 107 can be configured and arranged to cool the dehydrogenated stream to a temperature within a pre-selected phase separation temperature range for feeding to a phase separator 109 to facilitate the removal of moisture from the dehydrogenated stream (e.g., remove water as a liquid from the stream). For example, the cooled dehydrogenated stream 10 output from the cooler 107 can be fed to a phase separator 109 to form a liquid stream 50 that is comprised of water and a gaseous stream comprising oxygen 12 for feeding to an adsorption system 111 for further moisture removal and/or impurity removal. If the product does not require further drying, then stream 12 can directly form an oxygen gas product stream 24.

All of the gaseous stream comprising oxygen 12 can be fed to an adsorption system 111 for impurity removal (e.g. purification). In other implementations, the gaseous stream comprising oxygen 12 output from the phase separator 109 can be split so a first portion of the gaseous stream comprising oxygen 12 is fed to the adsorption system 111 and a second portion of the gaseous stream comprising oxygen 12 is fed to a regeneration heat exchanger 117 as a regeneration gas stream 20 for being heated and fed to at least one off-line adsorber of the adsorption system for regeneration of adsorbent material of the off-line adsorber(s).

In some embodiments, a phase separator 109 may not be utilized. Instead, the cooler 107 can cool the cooled dehydrogenated stream to a temperature within a pre-selected adsorption system feed temperature range for output of the cooled dehydrogenated stream 10 for passing to the adsorption system 111 as an adsorption system feed of dehydrogenated fluid 14 (shown in broken line in FIG. 1). In such a configuration, the cooler 107 can include at least one mist trap, one or more coalescing filters or other type of liquid retention mechanism for removing liquid from the cooled dehydrogenated stream 10 that can be formed from the cooling of the dehydrogenated feed provided by the cooler 107 (e.g. condensing of a water present within the dehydrogenated feed to a liquid via the cooling, etc.). That collected liquid can be output from the cooler 107 as a liquid waste stream (e.g. via a drain or other outlet).

As noted above, the adsorption system 111 can include at least one adsorber. For example, the adsorption system 111 can include a first adsorber 111a and a second adsorber 111b. The first adsorber 111a and second adsorber 111b can be switchable so that only one adsorber or set of adsorbers can process the gaseous stream comprising oxygen 12 for removal of moisture while the other adsorber or set of adsorbers is in an off-line state where it can undergo regeneration (e.g. via a stream of regeneration fluid passed through the off-line state adsorber(s) to remove impurities from the adsorbent material of the adsorber(s) for regeneration of the adsorbent material.). The adsorption system 111 can be configured to cycle the first adsorber 111a (or set of adsorbers) and the second adsorber 111b (or set of adsorbers) between on-line and off-line states so that one adsorber or set of adsorbers is off-line to undergo adsorbent material regeneration processing while the other adsorber or set of adsorbers is in an on-line state for adsorption of moisture or other impurities from the gaseous stream comprising oxygen 12.

The regeneration of adsorbent material can be provided via a flow of regeneration gas that is passed through the adsorber that is in an off-line state. The regeneration gas can be a plant process gas (e.g. a gas output from an air separation unit (ASU), a gas generator, etc.). The regeneration gas can also be provided by the apparatus via use of a liquefaction stream and/or a stream of gas output from the reactor 105 as discussed in some of the embodiments mentioned herein.

The adsorbers of the adsorption system 111 can be configured as vertical adsorbers, horizontal adsorbers and/or radial adsorbers. Each adsorber can include at least one bed of adsorbent material. The adsorbent material can include any type of suitable material for removal of impurities from the gaseous stream comprising oxygen 12 to meet a pre-selected set of design criteria. Examples of such adsorbent material can include silica, alumina and/or other suitable adsorbent material.

In some configurations, the adsorption system 111 can be implemented to provide pressure swing adsorption (PSA) or temperature swing adsorption (TSA). The adsorption system 111 can be configured to remove impurities (e.g., water) to facilitate formation of an oxygen gas stream 22 that can be output from the adsorption system 111. The oxygen gas stream 22 can be output for use as an oxygen gas product stream 24 and/or can be output for cryogenic processing and/or liquefaction. A portion of this oxygen gas stream 22a can also be utilized as a regeneration gas for the adsorption system. The oxygen content of the at least one stream 22 comprising oxygen can be between 80 vol % oxygen and 100 vol % oxygen, between 95 vol % oxygen and 100 vol % oxygen, between 95 vol % oxygen and 99.99 vol % oxygen, or other suitable pre-selected oxygen concentration.

The adsorption system 111 can also output a regeneration gas stream 23, which can be the output of regeneration gas passed through the one or more adsorbers that are in an off-line state for undergoing regeneration. The regeneration gas stream 23 can be output for venting as a purge stream or can be passed to a moisture removal unit 121 for further treatment of the regeneration gas and subsequent venting of that gas and/or recycling of that gas to a regeneration heat exchanger 117 (Regen HX) for subsequent use as a regeneration gas in a closed-loop arrangement. In some implementations where the regeneration gas stream 23 can be output for venting, it may first be passed to one or more other units for other uses (e.g. used as a heating medium for a heat exchanger, used for bubbling in electrolyzer water to remove dissolved impurities, etc.). In embodiments that may utilize the closed-loop arrangement for regeneration gas, a blower B can be positioned to facilitate the flow of the regeneration gas in such a closed-loop configuration.

In some implementations, the moisture removal unit 121 can be a third adsorber or set of adsorbers for moisture removal. The treated regeneration gas can be output as a purified regeneration gas stream 121r for being fed to the regeneration heat exchanger 117 to undergo heating therein for subsequent re-use as a regeneration gas stream. In other implementations, the moisture removal unit 121 can be a condenser or a dehydrator for removal of water from the regeneration gas stream as an impurity containing stream 121p output from the moisture removal unit 121. In such embodiments, the dried regeneration gas stream 121r output from the moisture removal unit 121 can be a purified regeneration gas that can be fed to the regeneration heat exchanger 117 to undergo heating therein for subsequent re-use as a regeneration gas stream or can be fed directly back to one or more off-line adsorbers of the adsorption system 111 for regeneration of adsorbent material for providing the regeneration gas in a closed-loop arrangement.

In other embodiments, the regeneration gas stream 23 output from the adsorption system 111 can be fed to the compressor 101 for being compressed and recycled back to the apparatus or can be recycled to the cooler 107 for being processed through the adsorption system 111 for further recovery of oxygen from within this gas.

A liquefaction unit 113 can be positioned downstream of the adsorption system 111 to receive at least a portion of the oxygen gas stream 22 output from the adsorption system 111. The liquefaction unit 113 can include at least one liquefier for liquifying the oxygen gas stream 22 to form an oxygen fluid stream 26 that includes liquid oxygen. The oxygen fluid stream 26 can be fed to a phase separator 115 to form a liquid oxygen product stream 28 as well as an oxygen gas stream 30. The oxygen concentration of each stream can be between 95 vol % and 100 vol % oxygen or other suitable oxygen concentration. The liquid oxygen product stream 28 can be fed to storage for use or transport. The oxygen gas stream 30 can be output from the phase separator 115 for subsequent use of the oxygen gas stream 30 as a cooling medium, regeneration gas, and/or as a product stream. For example, the oxygen gas stream 30 can be fed back to the liquefaction unit for use as a cooling medium therein and subsequently output as a process gas stream 32 for being fed to at least one heat exchanger of the apparatus 1 for use as a cooling medium and/or for being fed to the adsorption system 111 as a regeneration gas. After being used for cooling and/or as regeneration gas and before venting, this process gas stream 32 can also be used to remove dissolved impurities in electrolyzer water (e.g. being fed to a process unit for bubbling electrolyzer water, etc.).

For instance, the process gas stream 32 can be output to the regeneration gas heat exchanger 117 (Regen HX) as a regeneration gas stream 17f for being heated therein for use as a regeneration gas stream 42 fed to the adsorption system 111 for being passed through the adsorber(s) in the off-line state during operation of the apparatus 1. FIGS. 1, 2 and 6 illustrate examples of such an implementation.

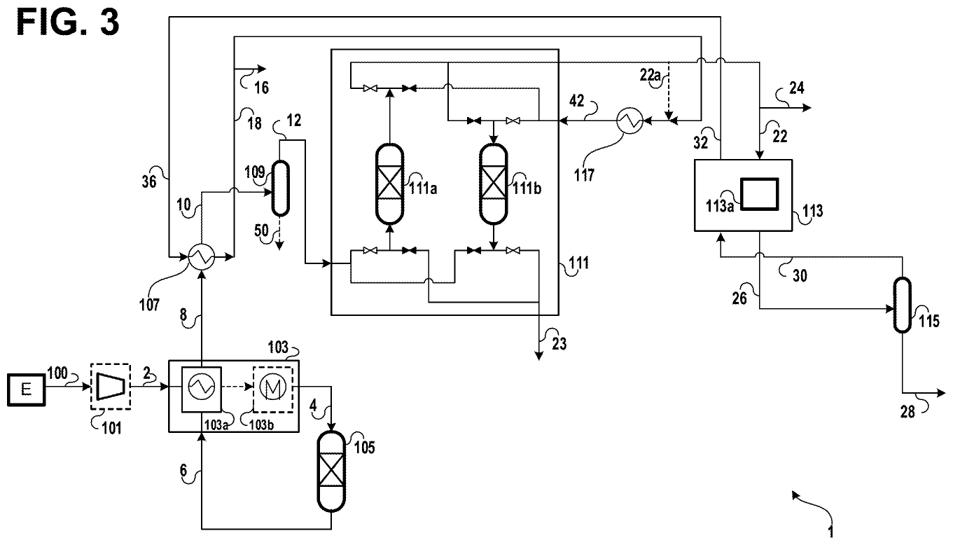

As another example, at least a portion of the process gas stream 32 can be output to at least one cooler 107 (O2 Cooler) as a cooling medium stream 36 to be fed to the cooler(s) for cooling the dehydrogenated stream before that stream is fed to the adsorption system 111 and/or the phase separator 109. The warmed oxygen process gas output from the cooler(s) 107 after being used as a cooling medium therein can be output for venting via a vent conduit 16 or can be fed to the regeneration heat exchanger 117 for heating and use as a regeneration gas stream via regeneration gas conduit 18 positioned between the at least one cooler 107 and the adsorption system 111. As noted above, before venting via vent conduit 16, the warmed oxygen process gas output from the cooler(s) 7 can be used for bubbling electrolyzer water to remove impurities or utilized in other process elements (e.g. a heat exchanger, etc.). FIGS. 1 and 3 illustrate examples of such implementations.

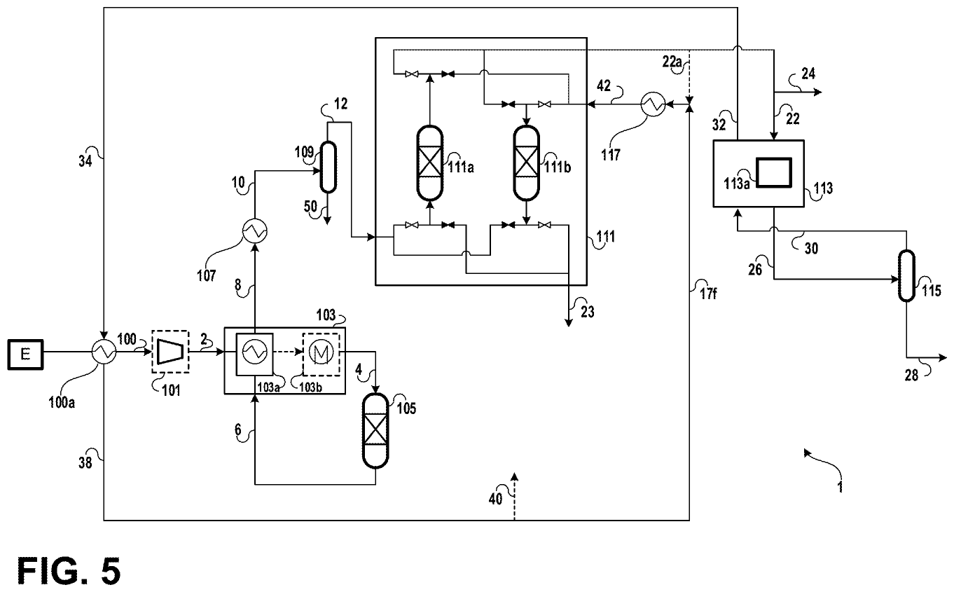

At least a portion of the process gas stream 32 can be output to a feed pre-treatment device 100a as a cooling medium stream 34 for cooling the feed 100 before the feed is fed to the compressor system 101 as well or as an alternative to use of the process gas stream 32 as a cooling medium stream 36 for the cooler(s) 107. The warmed stream of the process gas 38 comprising oxygen can be output from the feed pre-treatment device 100a after its use as a cooling medium for use as a product gas or venting 40 or for being fed to the regeneration heat exchanger 117 and/or the adsorption system 111 for use as a regeneration gas. As noted above, before venting, the warmed steam of the process gas 38 can be used for bubbling electrolyzer water to remove impurities or utilized in other process elements (e.g. a heat exchanger, etc.). FIGS. 1 and 5 illustrate examples of such implementations.

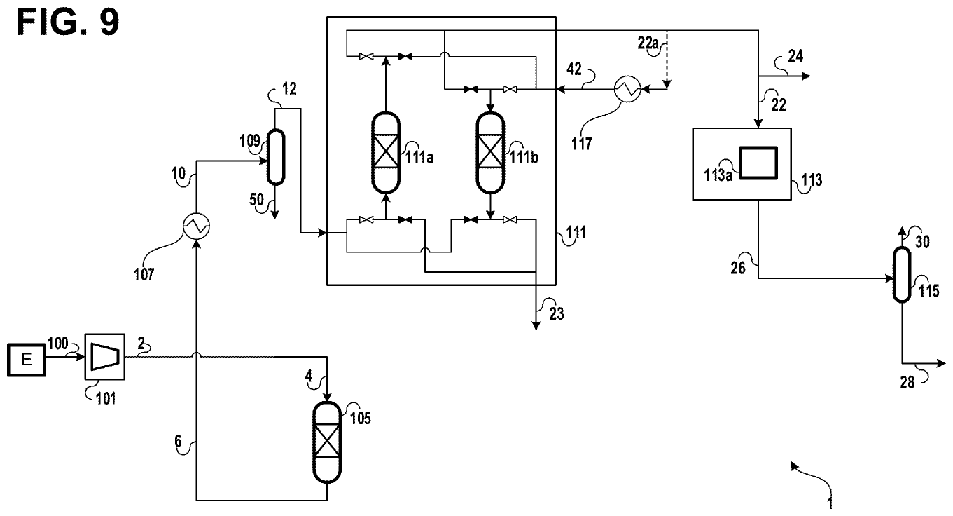

Some implementations of the apparatus 1 shown in FIG. 1 may not use a reactor feed heating system 103. Also, such embodiments may not use a gaseous oxygen stream output from the separator 115 as a cooling medium. For instance, an embodiment of the apparatus 1 can utilize a compressor system 101 to compress the feed 100 to a pre-selected processing pressure. Such compression can also heat the feed 100 sufficiently for pre-heating of the feed to a temperature within a pre-selected reactor feed temperature range. The compressed feed stream 2 output from the compressor system 101 can subsequently be fed to the reactor 105 as the heated compressed feed stream 4 for undergoing dehydrogenation via the reactor 105 to dehydrogenate the feed stream 4. The dehydrogenated stream 6 output from the reactor can include a first portion that is fed to the cooler 107 for cooling and subsequent phase separation and adsorption via the phase separator 109 and adsorption system 111. FIGS. 1 and 9 illustrate example of such an implementation, for example.

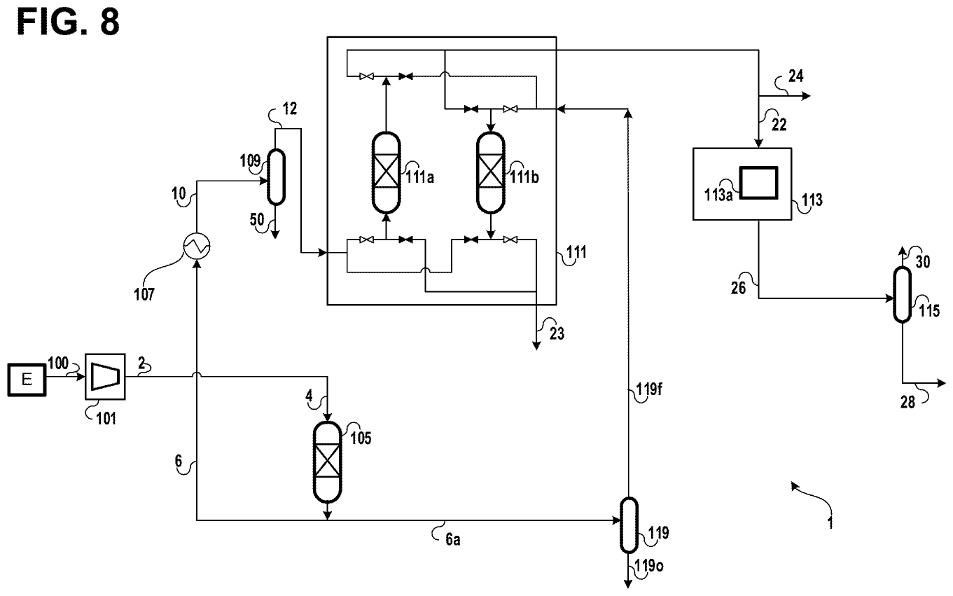

A regeneration gas portion 6a of the dehydrogenated stream 6 can be split out from the dehydrogenated stream 6 and fed to the adsorption system 111 as a regeneration gas for regeneration of adsorbent material within an off-line adsorber of the adsorption system 111. FIGS. 1 and 8 may best illustrate examples of such an implementation. For example, the regeneration gas portion 6a can be of a sufficient temperature for being fed directly to the off-line adsorber(s) of the adsorption system 111 for regeneration. In other implementations, the regeneration gas portion 6a can be fed to a treatment device 119 for removal of impurities from the regeneration gas portion 6a as a waste stream 1190 output from the treatment device 119. A regeneration gas feed 119f can be output from the treatment device 119 for passing the treated regeneration gas portion 6a to the adsorption system 111 for use as a regeneration gas flow for being passed to at least one off-line adsorber of the adsorption system 111. After use as a regeneration gas, the output used regeneration gas feed 119f can be fed to the compression system 101 for being recycled back into the apparatus for subsequent use or can be fed to the cooler 107 for further processing and use. In some embodiments, a supplemental blower can be provided to facilitate the merging used regeneration gas with the dehydrogenated stream 6 downstream of the cooler 107 or at the cooler 107 for recycling of the used regeneration gas for being fed to the cooler 107.

The treatment device 119 can also include a phase separator. The phase separator of the treatment device 119 can output the waste stream 1190 as a liquid or substantially liquid flow that includes water and/or other impurities from the regeneration gas portion 6a.

As discussed above, some embodiments of the apparatus 1 can be implemented so that the adsorption system 111 outputs a regeneration gas stream 23, which can be the output of regeneration gas passed through one or more adsorbers of the adsorption system 111 that are in an off-line state for undergoing adsorbent material regeneration. The regeneration gas stream 23 can be output for feeding to a moisture removal unit 121 for further treatment of the regeneration gas and subsequent venting of that gas and/or recycling of that gas to a regeneration heat exchanger 117 (Regen HX) for subsequent use as a regeneration gas in a closed-loop arrangement. A blower B can be positioned to facilitate the flow of the regeneration gas in such a closed-loop configuration between the adsorption system 111, moisture removal unit 121, and regeneration gas heat exchanger 117. In situations where the gas stream may be vented, the stream may first be utilized in other process elements (e.g. heat exchanger, bubbling electrolyzer feed water, etc.). FIGS. 1, 6, and 10 may best illustrate examples of this type of implementation for the apparatus 1.

As noted above, the moisture removal unit 121 can be a third adsorber or set of adsorbers for moisture removal. The treated regeneration gas can be output as a regeneration gas stream 121r for being fed to the regeneration heat exchanger 117 to undergo heating therein for subsequent re-use as a regeneration gas stream. In other implementations, the moisture removal unit 121 can be a condenser or a dehydrator for removal of water from the regeneration gas stream as an impurity containing stream 121p output from the moisture removal unit 121. In such embodiments, the dried regeneration gas stream 121r output from the moisture removal unit 121 can be fed to the regeneration heat exchanger 117 to undergo heating therein for subsequent re-use as a regeneration gas stream or can be fed directly back to one or more off-line adsorbers of the adsorption system 111 for regeneration of adsorbent material for providing the regeneration gas in a closed-loop arrangement.

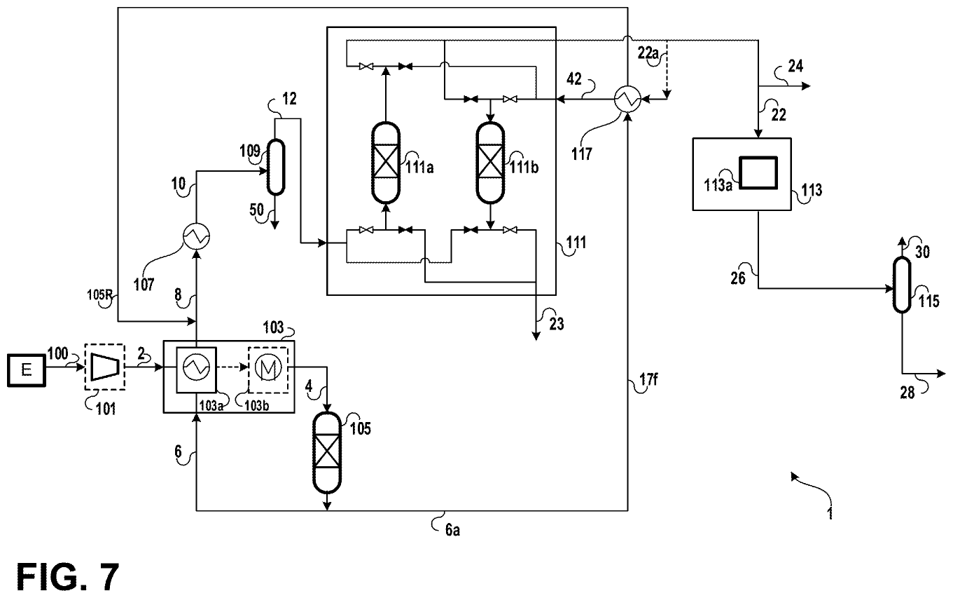

As discussed above, embodiments can be implemented so that a regeneration gas portion 6a of the dehydrogenated stream 6 can be split out from the dehydrogenated stream 6. Alternatively, the split of the dehydrogenated stream 6 can be provided so a portion of the dehydrogenated stream can be split to provide a regeneration gas heat exchanger heating medium portion 6a for being fed to the regeneration gas heat exchanger to function as a heating medium for heating the regeneration gas to a pre-selected regeneration gas temperature (e.g. a temperature within a pre-selected regeneration gas temperature range). In such a situation, the regeneration gas can be provided from another plant process (e.g. a product gas, a portion of liquefier flash gas, a portion 22a of the oxygen gas stream 22 output from the adsorption system 111, etc.) and/or can include a portion of the dehydrogenated stream after it has undergone cooling and/or phase separation (e.g. as a regeneration gas stream 20 portion of the dehydrogenated gas stream 12 output from the phase separator 109). The cooled regeneration gas heat exchanger heating medium portion 6a can be output from the regeneration gas heat exchanger 117 as a cooled dehydrogenated stream portion 105R for being merged with the dehydrogenated stream 6 before that stream is fed to the cooler 107 or at the cooler 107 for undergoing cooling before the dehydrogenated fluid is subsequently fed to the adsorption system 111 and/or phase separator 109. FIGS. 1 and 7 may best illustrate examples of such an implementation.

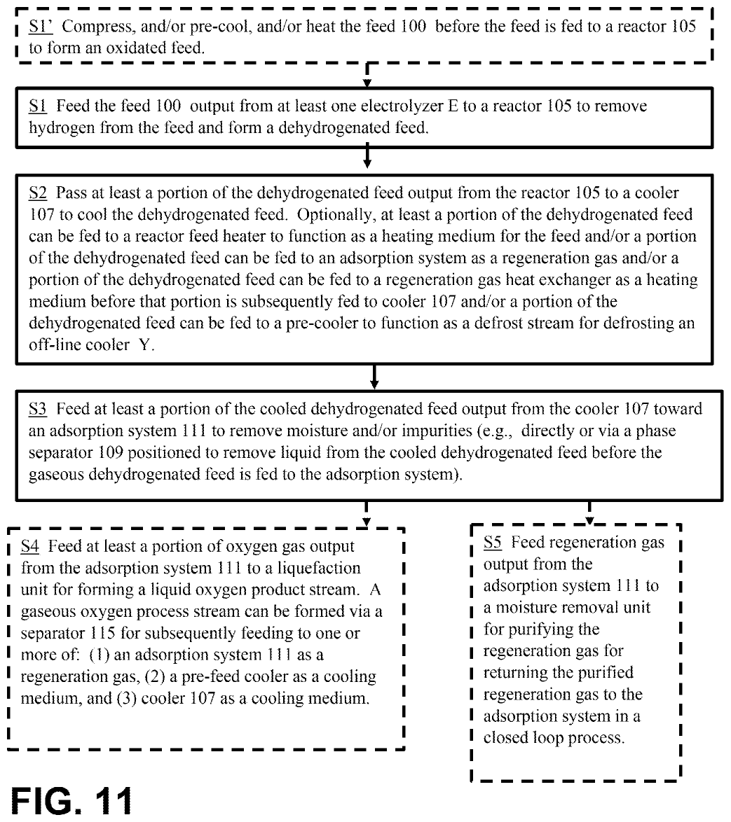

FIG. 11 illustrates an exemplary process for oxygen production. As can be appreciated from the above, this exemplary embodiment of the process can be utilized by the exemplary embodiment of the apparatus 1. The process illustrated in FIG. 11 includes an optional initial step S1′ shown in broken line, which can include compressing and/or pre-cooling and/or heating the feed 100 before the feed is fed to a reactor 105 to form a dehydrogenated feed 6. In a first step S1, the feed 100 output from at least one electrolyzer E can be fed to the reactor 105 for formation of the dehydrogenated feed. The feed 100 can include water, hydrogen, electrolyte material (e.g. KOH), and oxygen (e.g., as noted above). In a second step S2, the dehydrogenated feed can be output from the reactor 105 and at least a portion of it can be fed to the cooler 107 to cool the dehydrogenated feed. The cooler 107 can include a single cooler 107 or multiple coolers as noted above. The coolers can be arranged in series or in parallel as noted above as well. Optionally, at least a portion of the dehydrogenated feed can be split from the dehydrogenated feed before it is fed to the one or more coolers 107 for being (1) fed to an adsorption system 111 as a regeneration gas, and/or (2) a portion of the dehydrogenated feed can be fed to a regeneration gas heat exchanger 117 as a heating medium for heating a regeneration gas before that portion is then fed to the cooler 107 and/or merged with another portion of the dehydrogenated feed before that flow is fed to the cooler 107, and/or (3) a portion of the dehydrogenated feed can be fed to a pre-cooler to function as a defrost stream 6b for defrosting at least one off-line cooler Y as discussed above.

In a third step S3, at least a portion of the cooled dehydrogenated feed output from the cooler 107 can be passed to an adsorption system 111 for removal of moisture and/or impurities (e.g. removal of water or other impurities). The feeding of this portion of the cooled dehydrogenated feed can be passed to the adsorption system 111 directly or indirectly via the phase separator 109 as discussed above.

In an optional fourth step S4, at least a portion of oxygen gas output from the adsorption system 111 can be fed to a liquefaction unit to form a liquid oxygen product stream. Such a stream can be formed via a liquefier and subsequently passing the liquified oxygen to a phase separator 115 as discussed above, for example. A gaseous oxygen process stream 32 can be formed via the separator 115 for subsequently feeding that gas to one or more of: (1) an adsorption system 111 as a regeneration gas, and/or (2) a pre-feed cooler as a cooling medium, and/or (3) cooler 107 as a cooling medium as discussed above. After being used in such processing, the gaseous stream 32 can be used in other process elements prior to venting (e.g. bubbling as discussed above, use in a heat exchanger, etc.) and/or can be recycled back to the compressor system 101 as discussed above.

The process can also include an optional fifth step S5. The fifth step S5 can occur with the fourth step S4 also being performed or may occur while the fourth optional step S4 is not performed. The fifth step S5 can include feeding regeneration gas output from the adsorption system 111 to a moisture removal unit 121 for purifying the regeneration gas for returning the purified regeneration gas to the adsorption system 111 in a closed loop process. An example of such a closed-loop process arrangement for the regeneration gas can be appreciated from the above discussion of the exemplary utilization of moisture removal unit 121, for example.

Embodiments of the apparatus and process for oxygen production can provide significant improvements in recovery, efficiency and processing flexibility. For example, embodiments can permit utilization of flash vapor losses from the liquefaction unit and/or recovery of regeneration gas heat and/or utilization of compression of the feed 100 via the compressor system to permit improved heat integration and less wasteful processing for recovery of oxygen generated from electrolysis of water provided by electrolyzers E that also can produce hydrogen via the electrolysis of water. Embodiment can permit efficient process so that oxygen can be recovered and utilized as at least one product stream in addition to the formation of at least one hydrogen product stream via the electrolyzer(s) E, for example. Embodiments of the apparatus 1 can be configured for positioning upstream of a liquefaction unit, or liquefier to facilitate the improved operational flexibility, improved heat utilization, and reduction of waste.

Embodiments can permit oxygen to be recovered and provided as at least one gaseous product stream as well as at least one liquid product stream while other embodiments can be configured to only provide at least one gaseous oxygen product stream for storage and/or use or only provide at least one liquid oxygen product stream for storage and/or use.

It should be appreciated that modifications to the embodiments explicitly shown and discussed herein can be made to meet a particular set of design objectives or a particular set of design criteria. For instance, the arrangement of valves, piping, and other conduit elements (e.g., conduit connection mechanisms, tubing, seals, valves, etc.) for interconnecting different units of the apparatus for fluid communication of the flows of fluid between different elements (e.g., pumps, heat exchangers, cooling devices, chillers, compressors, etc.) can be arranged to meet a particular plant layout design that accounts for available area of the plant, sized equipment of the plant, and other design considerations. As another example, the flow rate, pressure, and temperature of the fluid passed through the various apparatus or system elements can vary to account for different design configurations and other design criteria. As yet another example, the embodiments discussed herein could also be applied to process a hydrogen stream coming from the electrolyzer.

Embodiments of the apparatus for oxygen production, process for oxygen production, and/or system for oxygen production can each be configured to include process control elements positioned and configured to monitor and control operations (e.g., temperature and pressure sensors, flow sensors, an automated process control system having at least one work station that includes a processor, non-transitory memory and at least one transceiver for communications with the sensor elements, valves, and controllers for providing a user interface for an automated process control system that may be run at the work station and/or another computer device of the plant, etc.). It should be appreciated that embodiments can utilize a distributed control system (DCS) for implementation of one or more processes and/or controlling operations of an apparatus as well.

As another example, it is contemplated that a particular feature described, either individually or as part of an embodiment, can be combined with other individually described features, or parts of other embodiments. The elements and acts of the various embodiments described herein can therefore be combined to provide further embodiments. Thus, while certain exemplary embodiments of the process, apparatus, system and methods of making and using the same have been shown and described above, it is to be distinctly understood that the invention is not limited thereto but may be otherwise variously embodied and practiced within the scope of the following claims.

What is claimed is:

1. An apparatus for oxygen production, the apparatus comprising:
a reactor positioned to receive a feed comprising oxygen and water for dehydrogenation of the feed and output dehydrogenated feed;
a cooler positioned to receive the dehydrogenated feed output from the reactor to cool the dehydrogenated feed to a temperature within a pre-selected temperature range; and
an adsorption system positioned to receive at least a portion of the cooled dehydrogenated feed after it is output from the cooler to remove moisture and/or impurities from the dehydrogenated feed to output an oxygen gas stream that is comprised of at least 90 volume percent (vol %) oxygen.

2. The apparatus of claim 1, comprising:
a compressor system positioned upstream of the reactor to compress the feed to a pre-selected reactor feed pressure before the feed is fed to the reactor; and/or
a reactor feed heating system positioned to heat the feed to a temperature within a pre-selected reactor feed temperature range before the feed is fed to the reactor and receive the dehydrogenated stream output from the reactor as a heating medium for heating the feed.

3. The apparatus of claim 2, comprising:
a liquefaction unit having at least one liquefier positioned to receive at least a portion of the oxygen gas stream output from the adsorption system to liquify the oxygen gas stream and a separator positioned to receive liquified oxygen from the liquefaction unit to output a liquid oxygen stream and an oxygen gas stream; and
a feed pre-cooler positioned upstream of the compressor system and/or the reactor feed heating system, the feed pre-cooler positioned to cool the feed before the feed is fed to the compressor system and/or the reactor feed heating system, the feed pre-cooler positioned to receive at least a portion of the oxygen gas stream output from the separator as a cooling medium to cool the feed.

4. The apparatus of claim 2, comprising:
a liquefaction unit having at least one liquefier positioned to receive at least a portion of the oxygen gas stream output from the adsorption system to liquify the oxygen gas stream and a separator positioned to receive liquified oxygen from the liquefaction unit to output a liquid oxygen stream and an oxygen gas stream, the oxygen gas stream being outputtable to feed at least a portion of the oxygen gas stream to the cooler as a cooling medium for cooling of the dehydrogenated feed;
the cooler positioned to output the cooling medium as a warmed cooling medium to feed toward the adsorption system as a regeneration gas for regeneration of adsorbent material of at least one adsorber of the adsorption system.

5. The apparatus of claim 2, comprising:
a liquefaction unit having at least one liquefier positioned to receive at least a portion of the oxygen gas stream output from the adsorption system to liquify the oxygen gas stream and a separator positioned to receive liquified oxygen from the liquefaction unit to output a liquid oxygen stream and an oxygen gas stream, the oxygen gas stream being outputtable to feed at least a portion of the oxygen gas stream toward the adsorption system as a regeneration gas for regeneration of adsorbent material of at least one adsorber of the adsorption system.

6. The apparatus of claim 5, comprising:
a regeneration gas heat exchanger positioned adjacent the adsorption system to receive the regeneration gas from the separator to heat the regeneration gas to a temperature within a pre-selected regeneration gas temperature range before the regeneration gas is fed to the at least one adsorber of the adsorption system to regenerate the adsorbent material of the at least one adsorber of the adsorption system.

7. The apparatus of claim 1, wherein the reactor is connectable to the adsorption system so that a portion of the dehydrogenated feed output from the reactor is feedable to the adsorption system as a regeneration gas.

8. The apparatus of claim 7, comprising a treatment device positioned between the reactor and the adsorption system to treat the portion of dehydrogenated feed output from the reactor to form the regeneration gas for feeding to the adsorption system.

9. The apparatus of claim 7, wherein the treatment device is a phase separator that outputs a liquid stream comprising impurities separated from the dehydrogenated feed to form the regeneration gas.

10. The apparatus of claim 1, comprising:
a regeneration gas heat exchanger positioned to heat a regeneration gas to a temperature within a pre-selected regeneration gas temperature range for feeding the regeneration gas to the adsorption system; and
wherein the reactor is connectable to the regeneration gas heat exchanger so that a portion of the dehydrogenated feed output from the reactor is feedable to the regeneration gas heat exchanger as a heating medium for heating the regeneration gas.

11. The apparatus of claim 10, wherein the regeneration gas heat exchanger is connectable to the cooler to feed the heating medium to the cooler or to merge the heating medium with the dehydrogenated feed stream output from the reactor for feeding to the cooler

12. The apparatus of claim 1, comprising:
a regeneration gas heat exchanger positioned to heat a regeneration gas to a temperature within a pre-selected regeneration gas temperature range for feeding the regeneration gas to the adsorption system; and
a moisture removal unit positioned between the adsorption system and the regeneration gas heat exchanger, the moisture removal unit configured to receive regeneration gas output from the adsorption system to remove moisture from the regeneration gas and subsequently feed the regeneration gas to the regeneration gas heat exchanger to be heated to the temperature within the pre-selected regeneration gas temperature range for being fed back to the adsorption system in a closed-loop arrangement.

13. The apparatus of claim 12, wherein the moisture removal unit comprises a dehydrator, a condenser, or an adsorber.

14. The apparatus of claim 1, comprising:
a phase separator positioned between the cooler and the adsorption system to remove water from the cooled dehydrogenated feed as a liquid waste stream before the cooled dehydrogenated feed is fed to the adsorption system.

15. The apparatus of claim 1, comprising;
a phase separator positioned between the cooler and the adsorption system to remove water from the cooled dehydrogenated feed as a liquid waste stream before a first portion of the cooled dehydrogenated feed is fed to the adsorption system;
a regeneration gas heat exchanger positioned between the phase separator and the adsorption system; and
wherein the phase separator is connectable to the adsorption system and the regeneration gas heat exchanger such that a second portion of the cooled dehydrogenated feed is feedable to the regeneration gas heat exchanger to be heated to a pre-selected regeneration gas temperature for being fed to the adsorption system as a regeneration gas.

16. A process for production of oxygen from a feed output from at least one electrolyzer, the process comprising:
feeding a feed output from at least one electrolyzer to a reactor to form a dehydrogenated feed, the feed comprising oxygen and water;
outputting the dehydrogenated feed from the reactor;
passing at least a portion of the dehydrogenated feed output from the reactor to a cooler to cool the dehydrogenated feed to a temperature within a pre-selected temperature range and for forming a cooled dehydrogenated feed;
feeding the cooled dehydrogenated feed towards an adsorption system to remove moisture and/or impurities from the cooled dehydrogenated feed to output an oxygen gas stream that is comprised of at least 90 volume percent (vol %) oxygen.

17. The process of claim 16, comprising at least one of:
compressing the feed to a pre-selected reactor feed pressure before the feed is fed to the reactor; and/or
heating the feed to a temperature within a pre-selected reactor feed temperature before the feed is fed to the reactor, the heating of the feed to the temperature within the pre-selected reactor feed temperature utilizing at least a portion of the dehydrogenated feed output from the reactor.

18. The process of claim 17, comprising:
liquifying at least a portion of the oxygen gas stream to form a liquified oxygen fluid after the oxygen gas stream is output from the adsorption system.

19. The process of claim 18, comprising:
feeding the liquified oxygen fluid to a separator to form a liquid oxygen product and an oxygen gas stream, the oxygen gas stream being utilizable as a process gas stream; and
at least one of:
feeding at least a portion of the process gas stream to a pre-feed cooler as a cooling medium for pre-cooling the feed before the feed is fed to the reactor and subsequently passing the cooling medium fed to the pre-feed cooler toward the adsorption system as a regeneration gas after the cooling medium is warmed via the pre-cooling of the feed;
feeding at least a portion of the process gas stream to the cooler as a cooling medium for cooling the dehydrogenated feed and subsequently passing the cooling medium fed to the cooler toward the adsorption system as a regeneration gas after the cooling medium is warmed via the cooling of the dehydrogenated feed;
feeding at least a portion of the process gas stream toward the adsorption system as a regeneration gas for passing through at least one off-line adsorber to regenerate adsorbent material of the at least one off-line adsorber; and
feeding at least a portion of the process gas stream to a regeneration gas heat exchanger to be heated to a temperature within a pre-selected regeneration gas temperature range for passing the portion of the process gas to the adsorption system as a regeneration gas for passing through at least one off-line adsorber to regenerate adsorbent material of the at least one off-line adsorber.

20. The process of claim 16, comprising one of:
(a) splitting the dehydrogenated feed output from the reactor so a first portion of the dehydrogenated feed is fed to the cooler and a second portion of the dehydrogenated feed is fed to the adsorption system as a regeneration gas;
(b) splitting the dehydrogenated feed output from the reactor so a first portion of the dehydrogenated feed is fed to the cooler and a second portion of the dehydrogenated feed is fed to a regeneration gas heat exchanger as a heating medium for heating a regeneration gas to be fed to the adsorption system and subsequently feeding the heating medium from the regeneration gas heat exchanger to the cooler after the heating medium is utilized for heating of the regeneration gas; and
(c) splitting the dehydrogenated feed output from the reactor so a first portion of the dehydrogenated feed is fed to the cooler and a second portion of the dehydrogenated feed is fed to a treatment device for forming a regeneration gas for feeding to the adsorption system and outputting the regeneration gas from the treatment device to feed the regeneration gas to the adsorption system.

21. The process of claim 16, comprising:
the adsorption system outputting a regeneration gas from at least one off-line adsorber of the adsorption system;
a moisture removal unit receiving the regeneration gas output from the adsorption system to remove moisture and/or impurities from the regeneration gas to purify the regeneration gas; and
feeding the purified regeneration gas output from the moisture removal unit to the adsorption system.
